(19) United States
(12) Patent Application Publication
(10) Pub. No.: US 2024/0134011 A1
(43) Pub. Date: Apr. 25, 2024

(54) TWO DIMENSIONAL TRANSMITTER ARRAY-BASED LIDAR

(71) Applicant: Innovusion, Inc., Sunnyvale, CA (US)

(72) Inventors: Xiandong Leng, San Jose, CA (US); Peng Wan, San Jose, CA (US); Yimin Li, Cupertino, CA (US); Yufeng Li, Milpitas, CA (US); Jia Ge, Milpitas, CA (US)

(73) Assignee: Innovusion, Inc., Sunnyvale, CA (US)

(21) Appl. No.: 18/380,911

(22) Filed: Oct. 16, 2023

Related U.S. Application Data
(60) Provisional application No. 63/418,405, filed on Oct. 21, 2022.

(51) Int. Cl. G01S 7/481; G01S 17/931

(52) U.S. Cl. CPC G01S 7/4815; G01S 7/4817; G01S 17/931

(57) ABSTRACT

A LiDAR system having two-dimensional transmitter array is provided. The LiDAR system comprises a light scanner, and a plurality of transmitter groups optically couplable to the light scanner. Each transmitter group of the plurality of transmitter groups comprises a plurality of transmitters. At least two transmitter groups of the plurality of transmitter groups are disposed at different positions with respect to the light scanner, such that scanning areas corresponding to the at least two transmitter groups are different. The LiDAR further comprises a control device configured to selectively control one or more of the plurality of transmitter groups to emit transmission beams toward the light scanner. The light scanner is configured to steer the transmission beams both vertically and horizontally to a field-of-view (FOV), and receive return light formed based on the steered transmission beams.

### CROSS-REFERENCE TO RELATED APPLICATIONS

This application claims priority to U.S. Provisional Patent Application Ser. No. 63/418,405, filed Oct. 21, 2022, entitled “TWO DIMENSIONAL TRANSMITTER ARRAY-BASED LIDAR” the content of which is hereby incorporated by reference in its entirety for all purposes.

### FIELD OF THE TECHNOLOGY

This disclosure relates generally to optical scanning and, more particularly, to a light ranging and detection (LiDAR) system having a two-dimensional transmitter array.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Embodiments provided in this disclosure use a two-dimensional transmitter array in a LiDAR system to achieve an ultra-wide FOV and customizable scanning patterns for complicated perception requirements. In one embodiment, the LiDAR system comprises a light scanner, and a plurality of transmitter groups optically couplable to the light scanner. Each transmitter group of the plurality of transmitter groups comprises a plurality of transmitters. At least two transmitter groups of the plurality of transmitter groups are disposed at different positions with respect to the light scanner, such that scanning areas corresponding to the at least two transmitter groups are different. The LiDAR further comprises a control device configured to selectively control one or more of the plurality of transmitter groups to emit transmission beams toward the light scanner. The light scanner is configured to steer the transmission beams both vertically and horizontally to a field-of-view (FOV), and receive return light formed based on the steered transmission beams.

In one embodiment, a vehicle comprising a light detection and ranging (LiDAR) system is provided. The LiDAR system comprises a light scanner, and a plurality of transmitter groups optically couplable to the light scanner. Each transmitter group of the plurality of transmitter groups comprises a plurality of transmitters. At least two transmitter groups of the plurality of transmitter groups are disposed at different positions with respect to the light scanner, such that scanning areas corresponding to the at least two transmitter groups are different. The LiDAR further comprises a control device configured to selectively control one or more of the plurality of transmitter groups to emit transmission beams toward the light scanner. The light scanner is configured to steer the transmission beams both vertically and horizontally to a field-of-view (FOV), and receive return light formed based on the steered transmission beams.

In one embodiment, a method for controlling a light ranging and detection (LiDAR) system is provided. The LiDAR system comprises a light scanner, and a plurality of transmitter groups optically couplable to the light scanner. The method comprises selectively controlling one or more of the plurality of transmitter groups to emit transmission beams toward the light scanner. At least two transmitter groups of the plurality of transmitter groups are disposed at different positions with respect to the light scanner, such that scanning areas corresponding to the at least two transmitter groups are different. The method further comprises steering the transmission beams both vertically and horizontally to a field-of-view (FOV), and receiving return light formed based on the steered transmission beams.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a diagram illustrating an example LiDAR system comprising a plurality of transmitter groups according to some embodiments.

FIGS. 8A-8E are diagrams illustrating examples of transmitter groups according to some embodiments.

FIG. 9 is a diagram illustrating an example of a transmitter group optically coupled to a collimation lens for directing transmission beams according to some embodiments.

FIGS. 10A-10B are diagrams illustrating examples of assemblies for a plurality of transmitter groups optically coupled to a plurality of collimation lenses and a collection lens according to some embodiments.

FIGS. 11A-11C are diagrams illustrating examples of a plurality of transmitter groups optically coupled to a light scanner according to some embodiments.

FIGS. 12A-12C are diagrams illustrating examples of scanning patterns generated by a plurality of transmitter groups according to some embodiments.

FIG. 13 shows an illustrative method for controlling a LiDAR system according to some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” “third,” etc. to describe various elements, these elements should not be limited by the terms. These terms are only used to distinguish one element from another. For example, a first transmitter group could be termed a second transmitter group or a third transmitter group, similarly, a second transmitter group could be termed a first transmitter group or a third transmitter group, and a third transmitter group could be termed a first transmitter group or a second transmitter group, without departing from the scope of the various described examples. The first transmitter group, the second transmitter group, and the third transmitter group all can be transmitter groups and, in some cases, can be separate and different transmitter groups.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

A LiDAR system may have one or more transmitters for transmitting laser beams. A LiDAR system's scanning capabilities can be improved by using a plurality of transmitters. For example, by using a plurality of transmitters, a wide FOV and a high scanning resolution can be obtained. On the other hand, a plurality of transmitters may make the LiDAR system bulky. For example, if each transmitter has its own optical and/or electrical components, the dimension of the transmitter may increase significantly. Existing LiDAR systems often have limited FOVs even when they are mounted into a small space of a vehicle (e.g., the rear-view mirror assembly, the light housing, the bumper, the rooftop or the like), because the small space limits the LiDAR's scanning capabilities. Therefore, there is a need for a compact LiDAR system that can fit into a small space and perform scanning of a wide FOV.

Further, a plurality of transmitters working all the time in the LiDAR system may cause a large amount of energy consumption. In turn, the overall cost of the LiDAR system also increases. It is desired to customize the scanning pattern configuration and specify regions with high density point cloud as needed. Therefore, there is a need for an energy-saving and cost-efficient mechanism to control the plurality of transmitters and fulfill complicated perception requirements.

Embodiments discussed herein improve a LiDAR system's scanning capacities and energy efficiency by using a plurality of transmitter groups and a control device configured to selectively control one or more of the plurality of transmitter groups. Each transmitter group of the plurality of transmitter groups comprises a plurality of transmitters. Benefiting from the plurality of transmitter groups, the LiDAR system can provide an ultra-wide FOV (e.g., beyond 120 degrees). The control device can selectively switch on-off states for one or more transmitter groups to save energy and fulfill complicated perception requirements. The control device can selectively adjust transmission orientations to achieve configurable scanning patterns and create customized high density point cloud regions. Wavelength can also be customized by using different types of laser sources for the plurality of transmitter groups.

Embodiments of present invention are described below. In various embodiments of the present invention, a LiDAR system having a two-dimensional transmitter array is provided. The LiDAR system comprises a light scanner, and a plurality of transmitter groups optically couplable to the light scanner. Each transmitter group of the plurality of transmitter groups comprises a plurality of transmitters. At least two transmitter groups of the plurality of transmitter groups are disposed at different positions with respect to the light scanner, such that scanning areas corresponding to the at least two transmitter groups are different. The LiDAR further comprises a control device configured to selectively control one or more of the plurality of transmitter groups to emit transmission beams toward the light scanner. The light scanner is configured to steer the transmission beams both vertically and horizontally to a FOV, and receive return light formed based on the steered transmission beams.

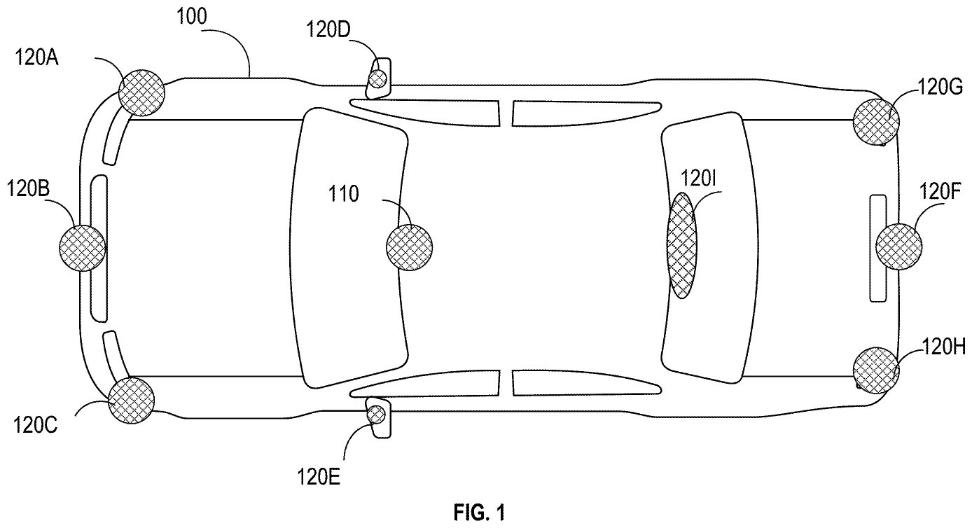

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

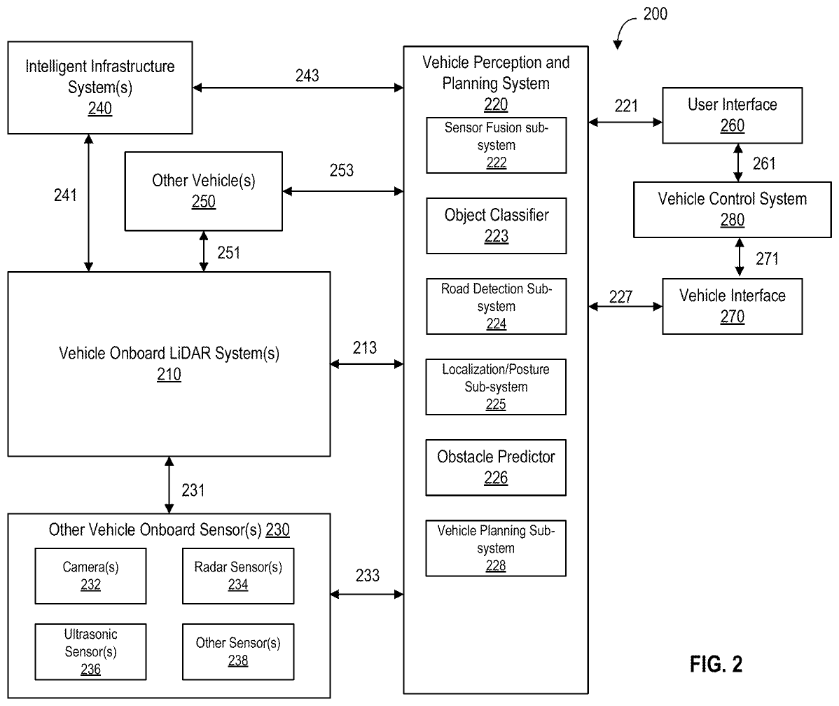

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensors(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mounted on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

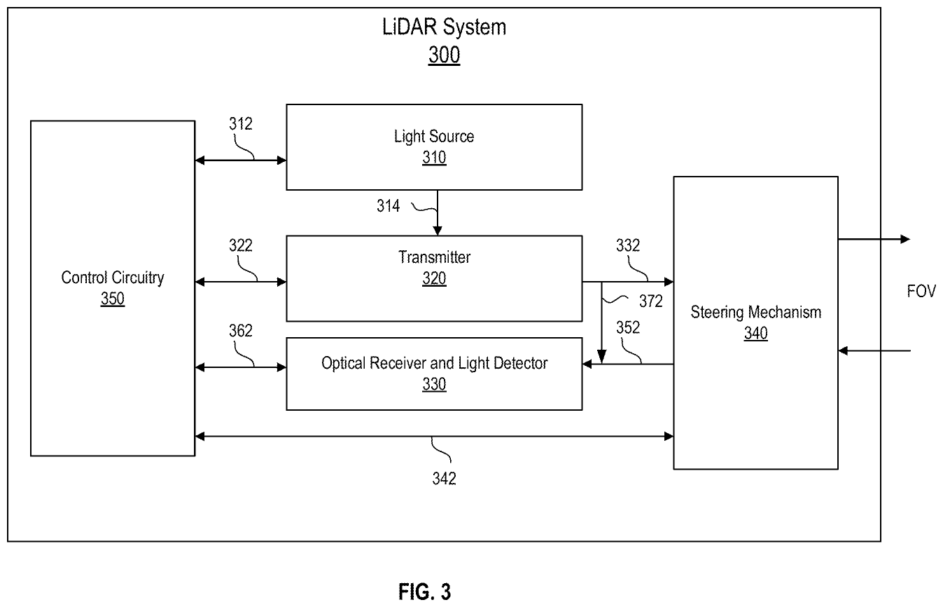

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

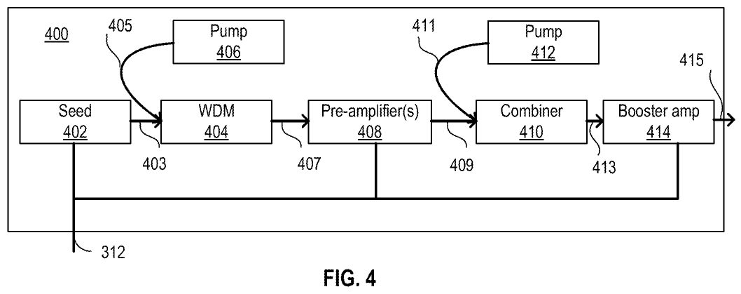

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

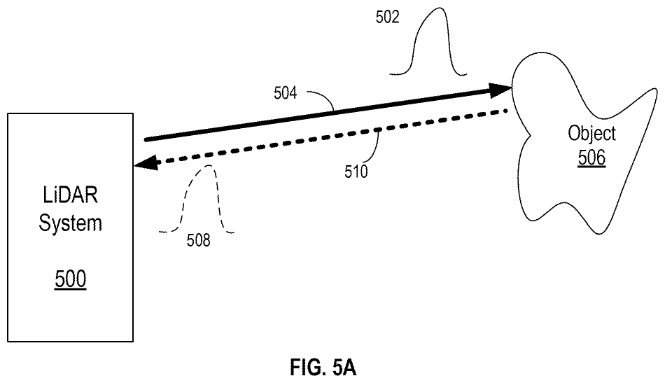

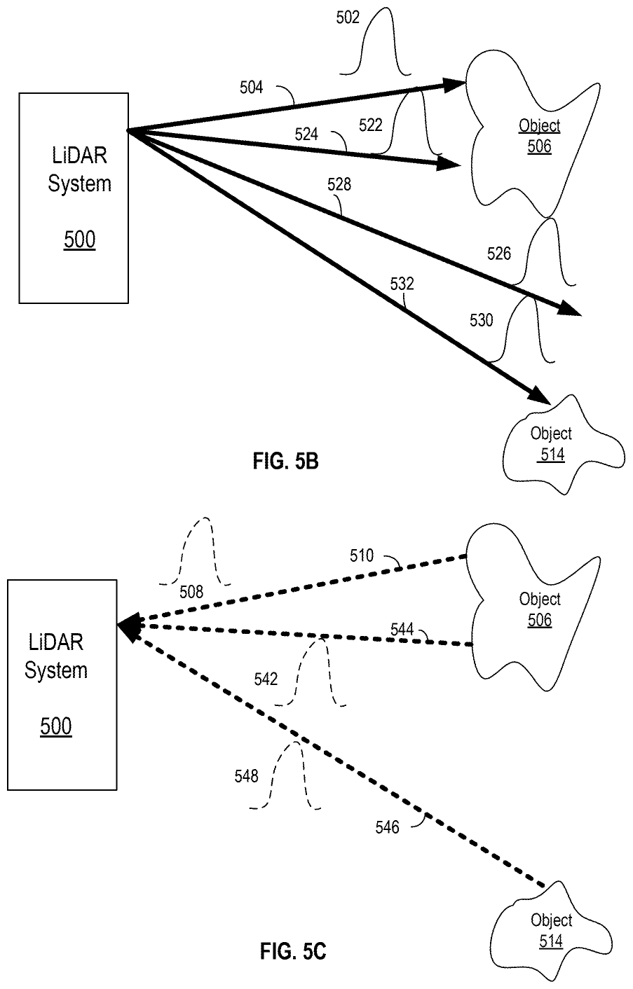

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

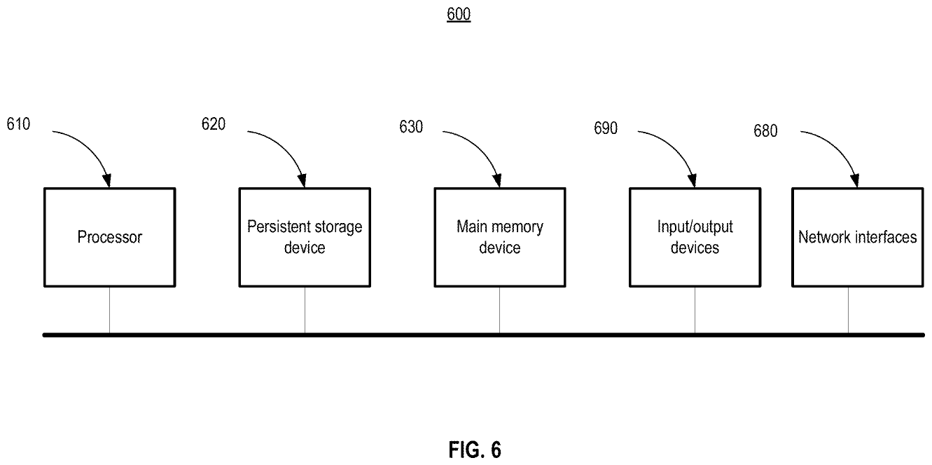

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

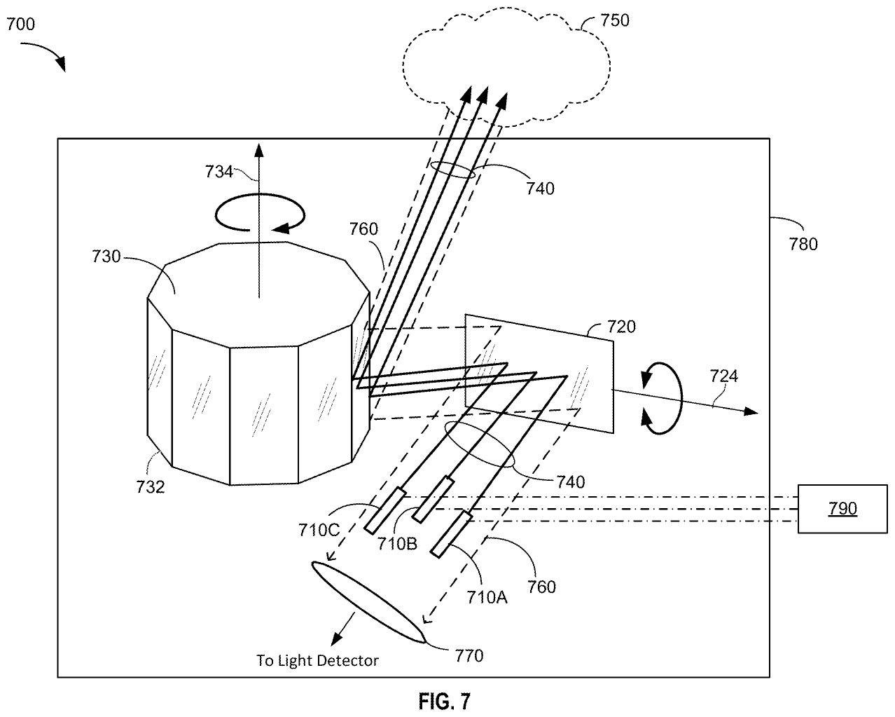

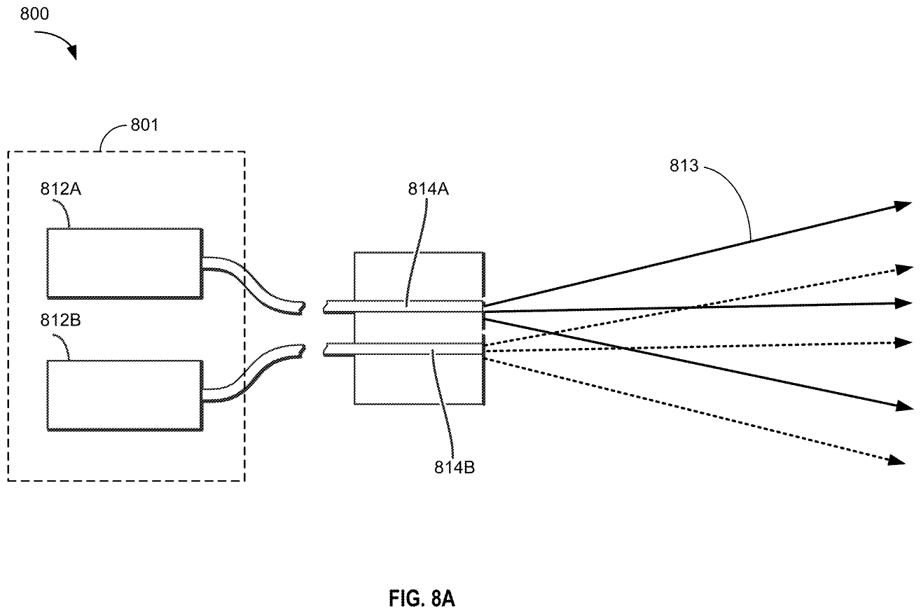

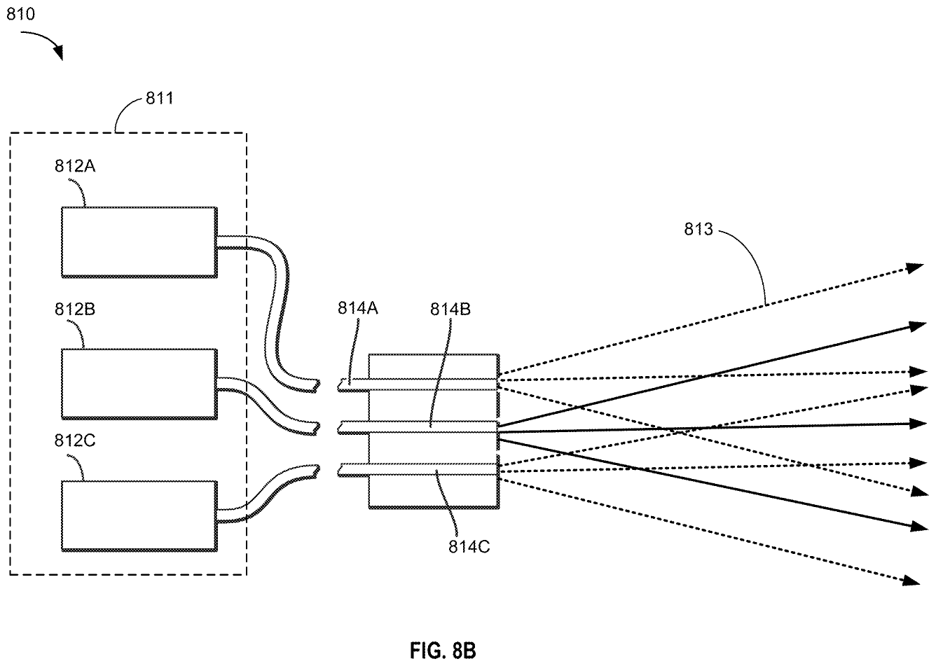

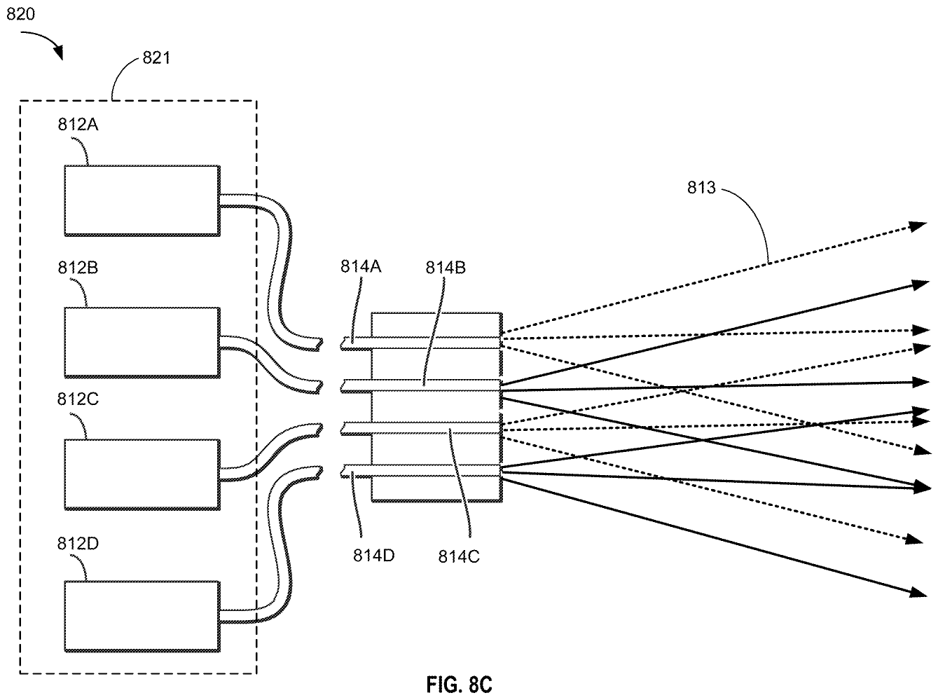

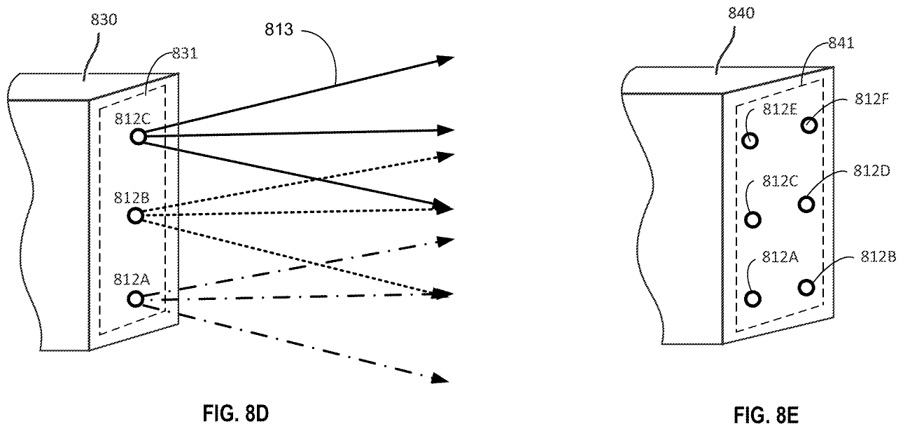

FIG. 7 is a diagram illustrating an example LiDAR system 700 comprising a plurality of transmitter groups according to some embodiments. As shown in FIG. 7, the LiDAR system 700 comprises a plurality of transmitter groups 710A, 710B, and 710C. FIG. 7 only illustrates three transmitter groups 710A, 710B, and 710C, but it is understood that more or fewer transmitter groups can be included. Transmitter groups 710A, 710B, and 710C are collectively referred to as transmitter group 710. Each transmitter group 710 of the plurality of transmitter groups 710A-C comprises a plurality of transmitters. In one example, the plurality of transmitter groups 710A-C form a plurality of transmitter arrays. Each of the transmitter arrays comprises a plurality of transmitters aligned with each other in at least one of a horizontal and vertical dimensions, thereby forming a two-dimensional transmitter array. This is described in detail further below with reference to FIGS. 8A-8E.

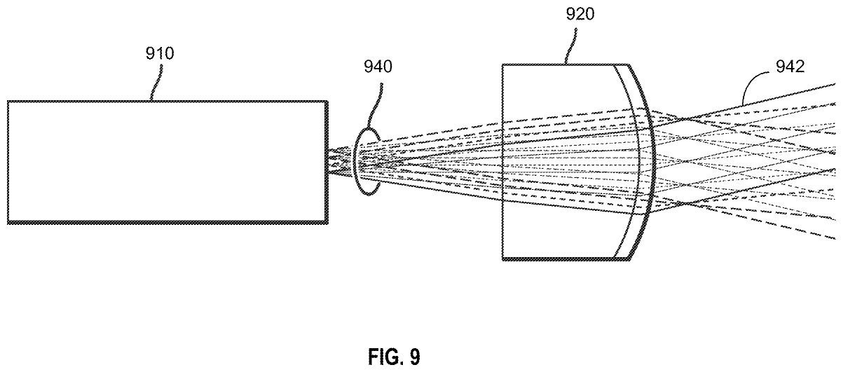

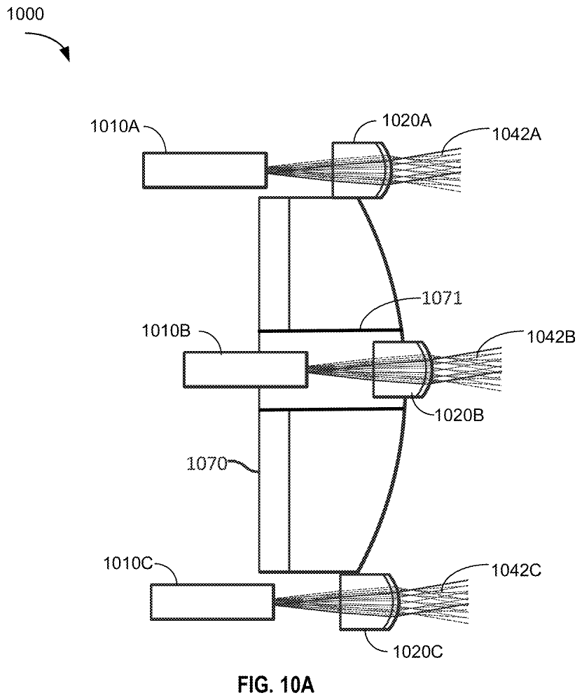

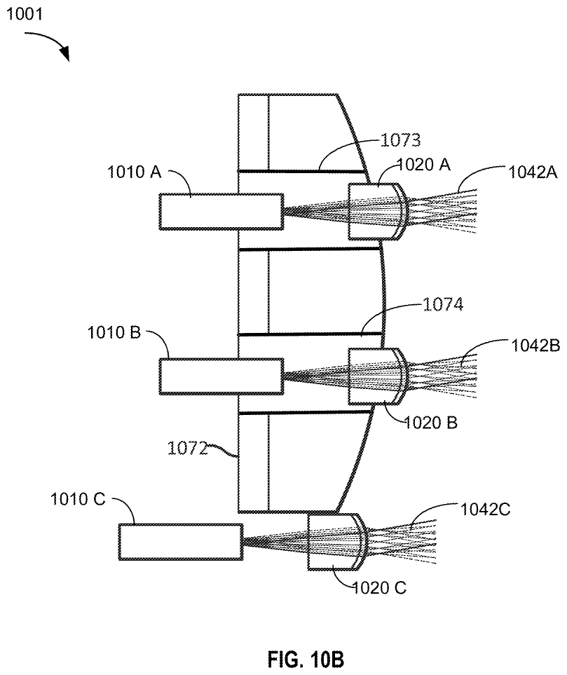

As shown in FIG. 7, the plurality of transmitter groups 710A-C is configured to emit transmission beams 740. In some embodiments, a collimation lens (not shown in FIG. 7) is optically coupled to each transmitter group 710 and configured to collimate the transmission beams 740. This is described in detail further below with reference to FIGS. 9 and 10. In some embodiments, the transmission beams 740 shown in FIG. 7 are collimated transmission beams.

In some embodiments, each transmitter group 710 comprises one or more laser sources to emit the transmission beams 740. In some embodiments, the plurality of transmitter groups 710A-C comprise one or more semiconductor-based laser sources and/or one or more fiber-based laser sources (e.g., fiber-based laser source 400 shown in FIG. 4). In some embodiments, at least two of plurality of transmitter groups 710A-C comprise different types of laser sources. In some embodiments, at least two of the plurality of transmitter groups 710A-C are configured to emit transmission beams 740 having different wavelengths. For example, the side transmitter group 710A or 710C comprises one or more semiconductor-based laser sources (e.g., 905 nm diode laser for short distance detection in a low-cost manner). The central transmitter group 710B comprises one or more fiber-based laser sources (e.g., 1550 nm fiber-based laser generating high quality point clouds for long distance detection). The transmitter groups comprising one or more fiber-based laser sources are described in detail further below with reference to FIGS. 8A-8C.

The LiDAR system 700 further comprises a light scanner (e.g., steering mechanism 340 shown in FIG. 3). The light scanner is configured to steer the transmission beams 740 both vertically and horizontally to a FOV 750, and receive return light 760 formed based on the steered transmission beams 740. In some embodiments, as shown in FIG. 7, the light scanner comprises a moveable mirror 720 and a polygon mirror 730. The plurality of transmitter groups 710A-C and the moveable mirror 720 of the light scanner are optically coupled together, such that the transmission beams 740 emitted by the plurality of transmitter groups are receivable by the moveable mirror 720. As shown in FIG. 7, the moveable mirror 720 is configured to direct the transmission beams 740 to the polygon mirror 730. The moveable mirror 720 can move about an axis 724 to facilitate scanning the transmission beams 740 alone a first dimension (e.g., the vertical dimension) of the FOV 750. In some embodiments, the moveable mirror 720 is an oscillation mirror. The moveable mirror is controlled to oscillate about the axis 724 between two predefined angular positions. In some embodiments, the moveable mirror 720 is a Galvanometer mirror configured to control the oscillation about the axis 724. As shown in FIG. 7, the polygon mirror 730 includes multiple reflective surfaces 732 configured to redirect the transmission beams 740 from the moveable mirror 720 to illuminate one or more objects in the FOV 750. The polygon mirror 730 rotates about an axis 734 to facilitate scanning the transmission beams 740 alone a second dimension (e.g., the horizontal dimension) of the FOV 750. The second dimension is orthogonal to the first dimension. When the transmission beams 740 travel to illuminate one or more objects in the FOV 750, at least a portion of transmission light beams 740 is reflected or scattered to form the return light 760. As shown in FIG. 7, the polygon mirror 730 receives the return light 760 and directs the return light 760 to the moveable mirror 720. The moveable mirror 720 redirects the return light 760 to a collection lens 770. Finally, the collection lens 770 directs the collected return light 760 to other components of the LiDAR system 700 (e.g., a light detector). In some embodiments, as shown in FIG. 7, the LiDAR system 700 further comprises a housing 780. The light scanner, including the movable mirror 720 and the polygon mirror 730, and the plurality of transmitter groups 710A-C are disposed within the housing 780. In one example, housing 780 includes a window for passing through light beams 740 and return light 760.

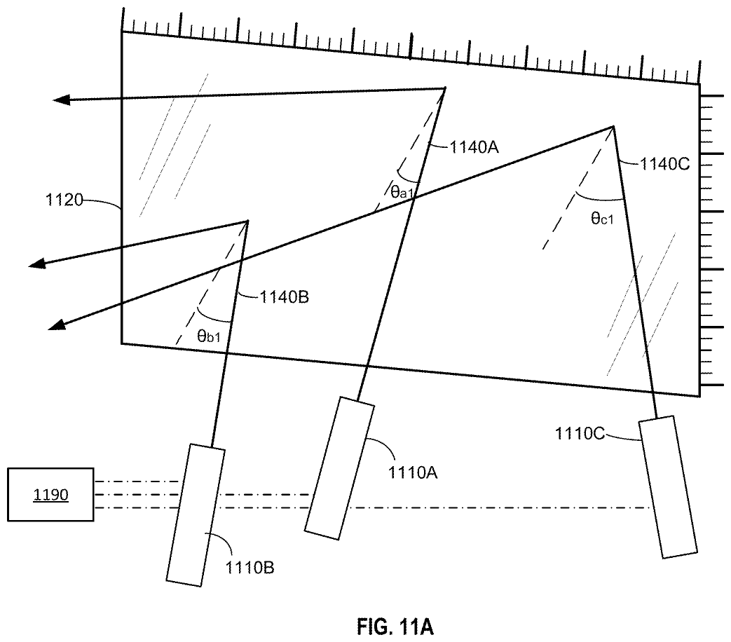

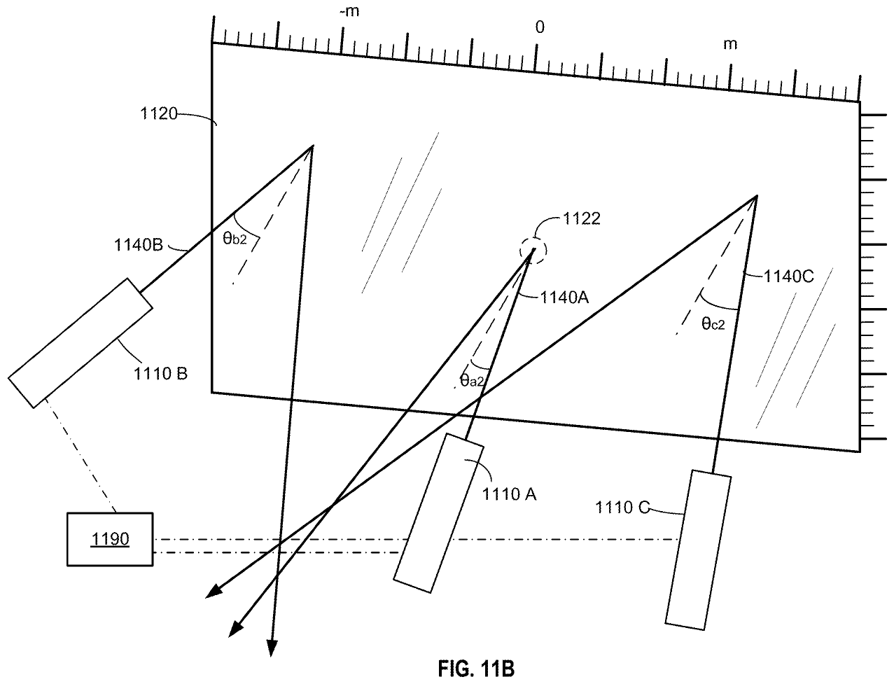

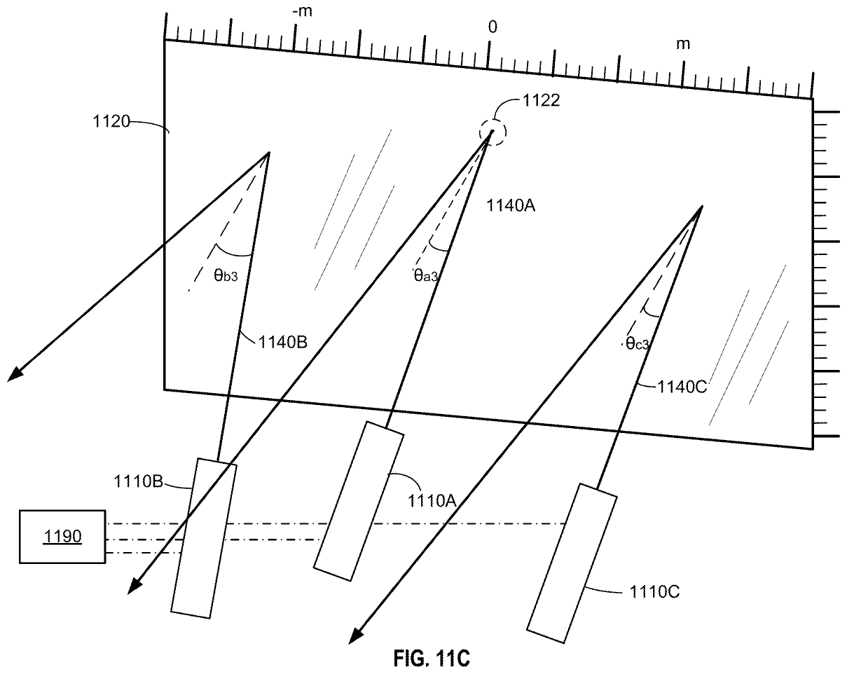

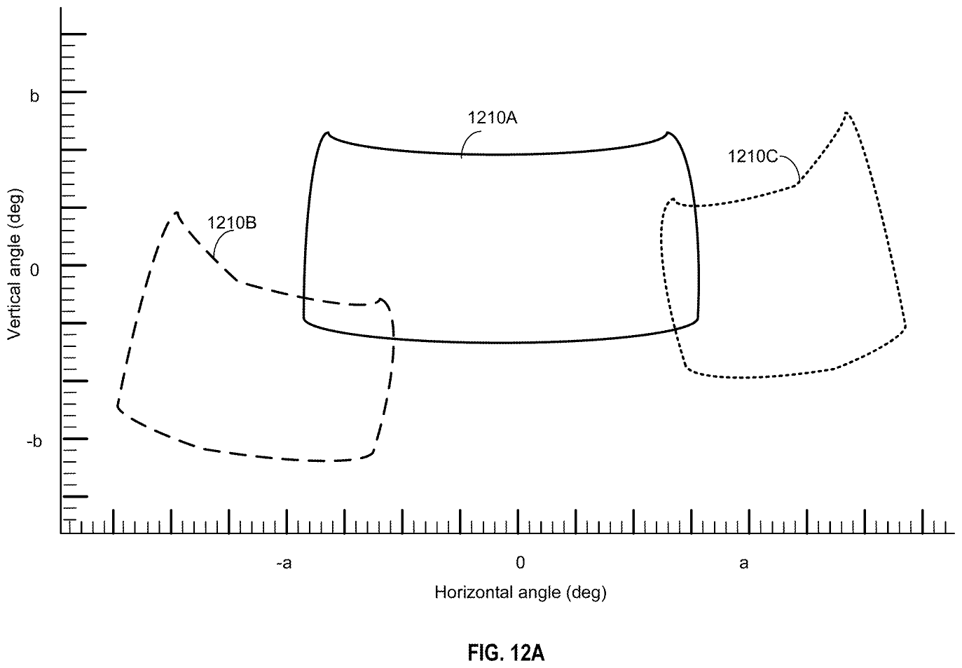

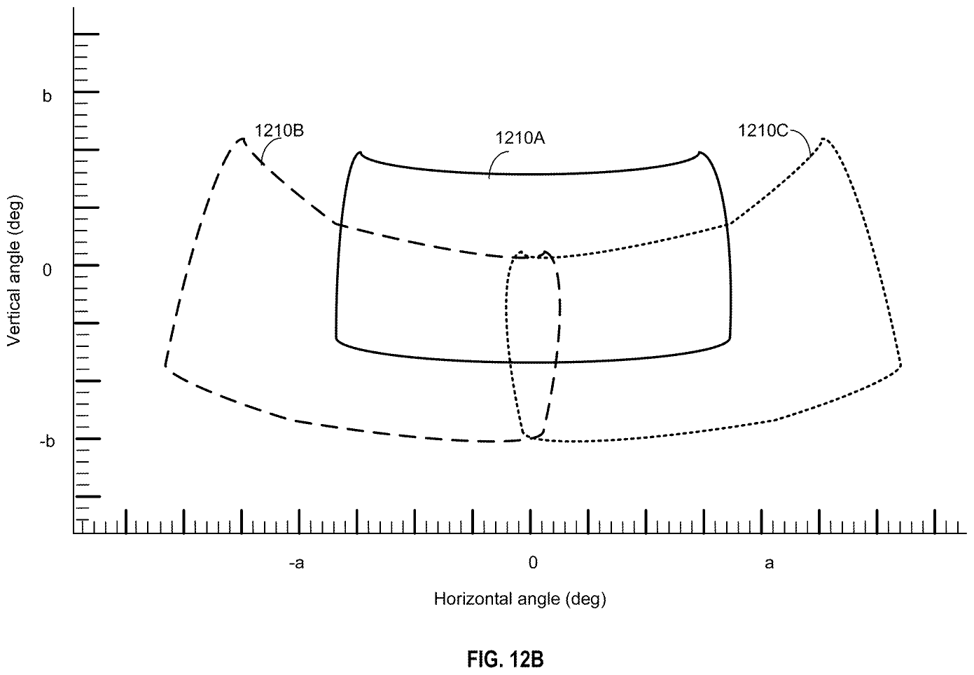

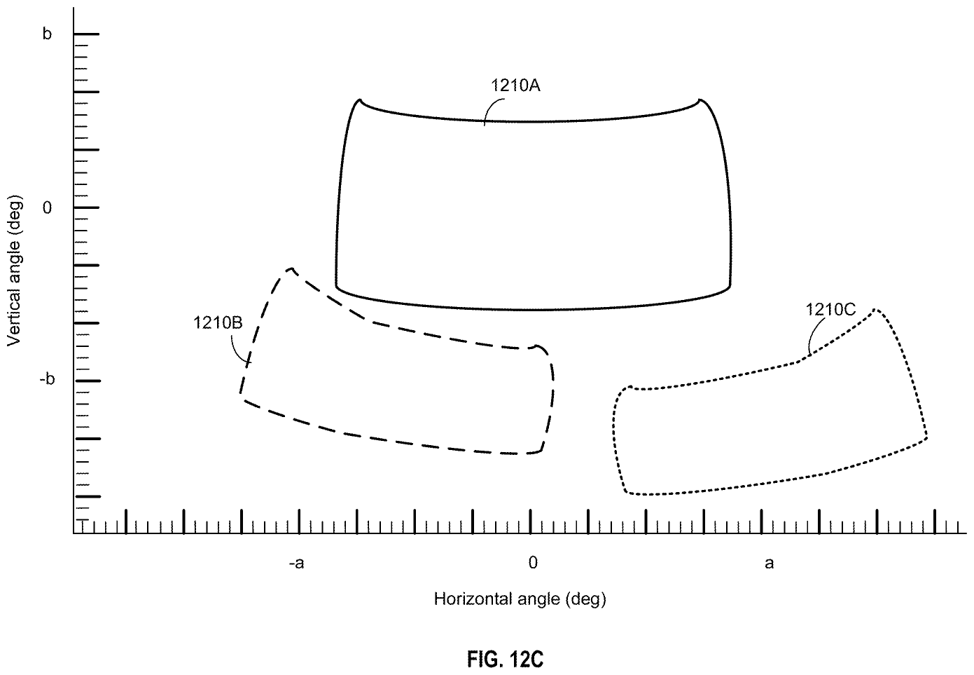

The LiDAR system 700 further comprises a control device 790 (e.g., control circuitry 350 shown in FIG. 3) configured to control the plurality of transmitter groups 710A-C. As shown in FIG. 7, a control device 790 selectively controls one or more of the plurality of transmitter groups 710A-C to emit transmission beams 740 toward the light scanner (e.g., moveable mirror 720). As shown in FIG. 7, at least two transmitter groups of the plurality of transmitter groups are disposed at different positions with respect to the light scanner (e.g., moveable mirror 720), such that scanning areas corresponding to the at least two transmitter groups are different. This is described in detail further below with reference to FIGS. 11 and 12.

In some embodiments, the control device 790 is configured to selectively control the one or more of the plurality of transmitter groups 710A-C by controlling at least one of: an on/off state of each of the one or more of the plurality of transmitter groups 710A-C; a pulse repetition rate of each transmission beam 740 emitted by the one or more of the plurality of transmitter groups 710A-C; a power level of each transmission beam 740 emitted by the one or more of the plurality of transmitter groups 710A-C; a wavelength of each transmission beam 740 emitted by the one or more of the plurality of transmitter groups 710A-C; an encoding or modulation scheme of each transmission beam 740 emitted by the one or more of the plurality of transmitter groups 710A-C; and a combination of the transmitter groups 710 that emit transmission beams 740 toward the light scanner (e.g., moveable mirror 720).

In some embodiments, the control device 790 is configured to selectively control the one or more of the plurality of transmitter groups 710A-C based on one or more perception requirements. One example of the perception requirements is associated with turning at intersections. When a vehicle having LiDAR system 700 makes a left turn, the control device 790 selectively controls two transmitter groups 710A and 710B to emit transmission beams 740. The control device 790 can shut off the transmitter group 710A, which may be located to the right side of transmitter groups 710B and 710C, to save energy, or reduce the power level of transmission beam 740 emitted by the transmitter group 710A such that it is in an energy-saving mode. Similarly, when the vehicle makes a right turn, the control device 790 can turn off the transmitter group 710C, which may be located to the left side of transmitter groups 710A and 710B, or reduce the power level of transmission beam 740 emitted by the transmitter group 710C, thereby improving the energy efficiency of the LiDAR system 700.

In another example, to facilitate complicated perception requirements, the control device 790 can selectively control the wavelengths of the transmission beams 740 provided by different transmitter groups 710. For example, control device 790 can control the transmission beam 740 emitted by the central transmitter group 710B to have a wavelength of 1550 nm for long distance detection. The control device 790 can selectively control the transmission beam 740 emitted by the two side transmitter groups 710A and 710C to have a wavelength of 905 nm for short distance detection. Further, by using low-cost diode lasers as laser sources in the two side transmitter groups 710A and 710C, the cost efficiency of the LiDAR system can be improved.

In another example, if the center area of the FOV 750 needs to have a higher scanning resolution, the control device 790 can selectively control the central transmitter group 710B to emit beams having a high pulse repetition rate for obtaining a high point cloud density in the central scanning area. To save energy, the control device 790 can further selectively control the two side transmitter groups 710A and 710C to emit beams having a low pulse repetition rate. Further, the control device 790 can selectively adjust transmission orientations and disposed positions of the plurality of transmission groups 710A-C with respect to the light scanner (e.g., moveable mirror 720). Therefore, the shape and point cloud density distribution can be customizable in the LiDAR system 700. It is understood that the pulse repetition rate, the shape, and the point cloud density distribution associated with any of the transmitter groups 710A-710C can be configured in any desired manner.

FIGS. 8A-8E are diagrams illustrating examples of transmitter groups 800-840 according to some embodiments. In some embodiments, each of the transmitter groups 800-840 can be anyone of the plurality of the transmitter groups 710A-C shown in FIG. 7. As shown in FIGS. 8A-8E, each of the transmitter groups 800-840 comprises a plurality of transmitters 812. In some examples, the plurality of transmitter groups 800-840 can form a plurality of transmitter arrays 801-841. Each of the transmitter arrays 801-841 comprises a plurality of transmitters 812 aligned with each other in at least one of a horizontal and vertical dimensions. Any one of the plurality of transmitter arrays 801-841 can comprise a n-by-m array; where 1≤n≤100 and 1≤m≤100.

FIG. 8A is a diagram illustrating an example of a transmitter group 800 according to one embodiment. The transmitter group 800 comprises a transmitter array 801. The transmitter array 801 comprises two transmitters 812A and 812B (collectively as 812) aligned with each other in a horizontal dimension. As shown in FIG. 8A, the two transmitters 812A and 812B can be semiconductor-based laser sources and/or fiber-based laser sources configured to emit transmission beams 813. The transmitter group 800 further comprises two fibers 814A and 814B arranged in a 1-by-2 fiber array.

FIG. 8B is a diagram illustrating another example of a transmitter group 810 according to one embodiment. The transmitter group 810 comprises a transmitter array 811. The transmitter array 811 comprises three transmitters 812A, 812B, and 812C (collectively as 812) aligned with each other in a horizontal dimension. As shown in FIG. 8B, the three transmitters 812A, 812B, and 812C can be semiconductor-based laser sources and/or fiber-based laser sources configured to emit transmission beams 813. As shown in FIG. 8B, the transmitter group 810 further comprises three fibers 814A, 814B, and 814C arranged in a 1-by-3 fiber array.

FIG. 8C is a diagram illustrating another example of a transmitter group 820 according to one embodiment. The transmitter group 820 comprises a transmitter array 821. The transmitter array 821 comprises four transmitters 812A, 812B, 812C, and 812D (collectively as 812) aligned with each other in a horizontal dimension. As shown in FIG. 8C, the four transmitters 812A-D can be semiconductor-based laser sources and/or fiber-based laser sources configured to emit transmission beams 813. As shown in FIG. 8C, the transmitter group 820 further comprises four fibers 814A, 814B, 814C, and 814D arranged in a 1-by-4 fiber array.

FIG. 8D is a diagram illustrating an example of a transmitter group 830 according to one embodiment. The transmitter group 830 comprises a transmitter array 831. The transmitter array 831 comprises three transmitters 812A, 812B, and 812C aligned with each other in a vertical dimension. In some embodiment, the transmitter group 830 comprises one or more semiconductor-based laser sources configured to emit transmission beams 813. In some embodiments, the transmitter group 830 comprises one or more fiber-based laser sources configured to emit transmission beams 813.

FIG. 8E is a diagram illustrating an example of a transmitter group 840 according to one embodiment. The transmitter group 830 comprises a transmitter array 841. The transmitter array 841 is a 3-by-2 array comprising six transmitters 812A-F aligned with each other in a horizontal and vertical dimensions. FIG. 8E only illustrates six transmitters 812A-F, but it is understood that more transmitters can be included. Also, it is understood that a plurality of transmitters can be arranged in a n-by-m array; where 1≤n≤100 and 1≤m≤100. In some embodiment, the transmitter group 840 comprises one or more semiconductor-based laser sources configured to emit transmission beams 813. In some embodiments, the transmitter group 840 comprises one or more fiber-based laser sources configured to emit transmission beams 813.

FIG. 9 is a diagram illustrating an example of a transmitter group optically coupled to a collimation lens for directing transmission beams according to some embodiments. As shown in FIG. 9, a transmitter group 910 comprises a plurality of transmitters configured to emit transmission beams 940. In some embodiments, the plurality of transmitters of transmitter group 910 forms a transmitter array. The transmitter group 910 can be any one of the transmitter groups 710A-C shown in FIG. 7 and transmitter groups 800-840 shown in 8A-8E. As shown in FIG. 9, a collimation lens 920 is positioned to be optically coupled to the transmitter group 910 to receive transmission beams 940. As the transmission beams 940 travel towards the collimation lens 920 in free space, they expand in their spatial cross-sectional areas. When they reach the collimation lens 920, the transmission beams 940 spatially overlap. As shown in FIG. 9, the collimation lens 920 receives the transmission beams 940 and collimates them to form collimated transmission beams 942. The collimated beams 942 have much smaller divergence compared to the transmission beams 940, which allows them to reach further distance with concentrated energy. The collimated transmission light beams 942 can correspond to transmission beams 740 shown in FIG. 7. By using one collimated lens 920 optically coupled with the plurality of transmitters (e.g., four transmitters shown using four kinds of dashed/solid lines in FIG. 9) in the transmitter group 910, the dimension of the transmitter group 910 does not increase much, thereby keeping a LiDAR system compact.

FIGS. 10A and 10B illustrate examples of assemblies 1000 and 1001 for a plurality of transmitter groups optically coupled to a plurality of collimation lenses and a collection lens according to some embodiments. In each of the assemblies 1000 and 1001, there are a plurality of transmitter groups 1010A, 1010B, and 1010C (collectively as transmitter group 1010). A transmitter group 1010 can be used to implement the transmitter group 710 shown in FIG. 7, any one of the transmitter groups 800-840 shown in FIGS. 8A-8E, and the transmitter group 910 shown in FIG. 9. As shown in FIGS. 10A and 10B, collimation lenses 1020A, 1020B, and 1020C (collectively as collimation lens 1020) are configured to collimate beams emitted from the plurality of the transmitter groups 1010A-C. One collimation lens 1020 is optically coupled to one transmitter group 1010. To achieve a LiDAR system having a very compact size, the plurality of transmitter groups 1010A-C can share a single collection lens (e.g., collection lens 1070 or 1072 shown in FIGS. 10A and 10B). The collection lens corresponds to the collection lens 770 shown in FIG. 7. Compared with the plurality of collimation lenses 1020A-C, the collection lens has a larger optical receiving aperture and is configured to collect as much return light as possible. The return light is formed based on the transmission beams 1042A-C provided by the plurality of transmitter groups 1010A-C.

FIG. 10A illustrates that the collection lens 1070 comprises an opening 1071. The opening 1071 may be a rectangular-shaped opening, a circular-shaped opening, a square shaped opening, a slot, a hole, a slit, or any other shaped opening. As shown in FIG. 10A, the opening 1071 is made from the curved frontside surface to the flat backside surface of the collection lens 1070. In some embodiments, one of the plurality of transmitter groups 1010A-C is at least partially disposed in the opening 1071, or disposed on a side of the collection lens 1070. As shown in FIG. 10A, the transmitter groups 1010A and 1010C optically coupled to the collimation lenses 1020A and 1020C, respectively, are disposed at the sides of the collection lens 1070. In some embodiments, the assembly 1000 can further comprise one or more optical beam-shifting systems couple to the transmitter group 1010A and/or 1010C. The optical beam-shifting system comprises a periscope prism configured to shift transmission beams 1042A or 1042C to be positioned within the optical receiving aperture of the collection lens 1070.

As shown in FIG. 10A, the transmitter group 1010B optically coupled to the collimation lens 1020B is disposed in the opening 1071 of the collection lens 1070. Because of the opening 1071, the transmission beams 1042B can be transmitted through the collection lens 1071 to scan a FOV. The position of the collimation lens 1020B can be configured such that collimated transmission beams 1042B are positioned at a select location within the optical receiving aperture of the collection lens 1070 to optimize collection of the return light. In one embodiment, the opening 1071 is located at or around the center of the collection lens 1070's optical receiving aperture.

FIG. 10B illustrates another example of assembly 1001 comprising a collection lens 1072 with two openings 1073 and 1074. The openings 1073 and 1074 may be rectangular-shaped openings, circular-shaped openings, square shaped openings, a slot, a hole, a slit, or any other shaped openings. As shown in FIG. 10B, the transmitter group 1010A optically coupled to the collimation lens 1020A is disposed in the opening 1073 of the collection lens 1072. The transmitter group 1010B optically coupled to the collimation lens 1020B is disposed in the opening 1074 of the collection lens 1072. Because of the openings 1073 and 1074, the transmission beams 1042A and 1042B can be transmitted through the collection lens 1072 to scan a FOV. To optimize collection of the return light, positions of the collimation lenses 1020A and 1020B can be configured such that collimated transmission beams 1042A and 1042B are positioned at select locations within the optical receiving aperture of the collection lens 1072. As shown in FIG. 10A, the transmitter group 1010C optically coupled to the collimation lens 1020C is disposed on a side of the collection lens 1072. In some embodiments, the assembly 1001 can further comprise an optical beam-shifting systems couple to the transmitter group 1010C, to shift transmission beams 1042C to be positioned within the optical receiving aperture of the collection lens 1072. FIGS. 10A and 10B illustrate two examples of positioning the collimation lenses and openings with respect to the collection lens. It is understood that other configurations can be made for transmitting the light beams through or around the collection lens.

FIGS. 11A-11C are diagrams illustrating examples of a plurality of transmitter groups optically coupled to a light scanner according to some embodiments. As shown in FIGS. 11A-11C, there are a plurality of transmitter groups 1110A, 1110B, and 1110C (collectively as transmitter group 1110) configured to emit transmission beams 1140A, 1140B, and 1140C, respectively, toward to a light scanner 1120. Each transmitter group 1110 comprises a plurality of transmitters. One transmitter group 1110 can be used to implement the transmitter group 710 shown in FIG. 7, any one of the transmitter groups 800-840 shown in FIGS. 8A-8E, the transmitter group 910 shown in FIG. 9, and the transmitter group 1010 shown in FIGS. 10A-10B. As shown in FIGS. 11A-11C, the light scanner 1120 is a moveable mirror configured to steer the transmission beams 1140A-C to a FOV. The light scanner 1120 is also configured to receive return light formed based on the steered transmission beams 1140A-C. Referencing back to FIG. 7, the light scanner 1120 corresponds to the moveable mirror 720 or a reflective surface 732 of the polygon mirror 730 shown in FIG. 7.

With reference still to FIGS. 11A-11C, in some embodiments, the plurality of transmitter groups 1110A-C and the moveable mirror of the light scanner 1120 are optically coupled together, such that transmission beams 1140A-C emitted by the plurality of transmitter groups 1110A-C are receivable by the moveable mirror 1120. As shown in FIGS. 11A-11C, a control device 1190 is configured to selectively control one or more of the plurality of transmitter groups 1110A-C to emit transmission beams 1140A-C toward the light scanner 1120. The control device 1190 can be the same as or similar to control device 790 shown in FIG. 7 and/or control circuitry 350 shown in FIG. 3. As shown in FIGS. 11A-11C, the plurality of transmitter groups 1110A-C can be disposed at different positions with respect to the light scanner 1120, such that scanning areas corresponding to the transmitter groups 1110A-C are different. The control device 1190 selectively controls an encoding or modulation scheme of each transmission beam 1140A-C emitted by the one or more of the plurality of transmitter groups 1110A-C. For example, transmission beam 1140A may have an amplitude modulation, while transmission beam 1140B may have a phase modulation. In another example, the encoding of the transmission beams 1140A-C can be different, such that return light formed based on the different transmission beams can be distinguished based on the different encoding schemes. As shown in FIGS. 11A-11C, the control device 1190 can selectively adjust transmission orientations and disposed positions of the plurality of transmission groups 1110A-C with respect to the light scanner 1120. As a result, scanning patterns with customizable shape and point cloud density distribution are obtained. This is described in detail further below with reference to FIGS. 12A-12C.

As shown in FIGS. 11A-11C, the plurality of transmitter groups 1110A-C comprises a first transmitter group 1110A, a second transmitter group 1110B, and a third transmitter group 1110C. The second transmitter group 1110B is disposed at the left side of the first transmitter group 1110A. The third transmitter group 1110C is disposed at the right side of the first transmitter group 1110A. The control device 1190 is configured to control a combination of the three transmitter groups 1110A-C that emit transmission beams 1140A-C toward the light scanner 1120 to achieve customized scanning pattern configurations. This is described in detail further below with reference to FIGS. 12A-12C.

In some embodiments, one or more characteristics associated with the plurality of transmitter groups 1110A-C are configured based on at least one of a vertical FOV requirement or a horizontal FOV requirement. As shown in FIGS. 11A-11C, horizontal and vertical scales on the light scanner 1120 illustrate relative positions of the transmission beams 1140A-C corresponding to the FOV. The one or more characteristics comprise horizontal distances between the plurality of transmitter groups 1110A-C, vertical distances between the plurality of transmitter groups 1110A-C, and tilt angles θₐ, θ_{b}, and θ_{c} associated with each of the plurality of transmitter groups 1110A-C. As shown in FIGS. 11A-11C, the tilt angle θₐ, θ_{b}, or θ_{c} is an angle between the normal direction of the light scanner 1120 and the corresponding transmission beam 1140A, 1140B, or 1140C, respectively. The transmission beams 1140A-1140C are emitted from respective transmitter groups 1110A-1110C toward the light scanner 1120.

FIG. 11A illustrates that, in one embodiment, the plurality of transmitter groups 1110A-C have different horizontal positions, different vertical positions, and/or different tilt angles (i.e., θₐ₁≠θ_{b1}≠θ_{c1}). The letter a, b, or c in the subscript denotes the tilt angle associated with the corresponding transmitter groups 1110A, 1110B or 1110C. The number 1 in a subscript denotes the tilt angle at the particular angular position of light scanner 1120 shown in FIG. 11A. As described above, light scanner 1120 can be controlled to oscillate and thus, at any particular angular position, the tilt angle of a light beam 1140 emitted by a particular transmitter 1110 may be different from another angular position. As shown in FIG. 11A, the second transmitter group 1110B and the third transmitter group 1110C are asymmetrically (i.e., θ_{b1}≠θ_{c1}) spaced apart from the first transmitter group 1110A. The horizontal distances between the plurality of transmitter groups 1110A-C are configured such that the horizontal FOV scannable by transmission beams 1140A-C emitted from the plurality of transmitter groups 1110A-C is greater than, or different from, the horizontal FOV scannable by transmission beams 1140A emitted from a single transmitter group 1110A. Similarly, the vertical distances between the plurality of transmitter groups 1110A-C are configured such that the vertical FOV scannable by transmission beams 1140A-C emitted from the plurality of transmitter groups 1110A-C is greater than, or different from, the vertical FOV scannable by transmission beams 1140A emitted from a single transmitter group 1110A. The scanning pattern as a result of this configuration is described in detail further below with reference to FIG. 12A.

FIG. 11B illustrates the first transmitter group 1110A is positioned and/or oriented such that transmission beams 1140A are directed toward a position 1122 aligned with a center optical axis of the moveable mirror of the light scanner 1120. As shown in the FIG. 11B, the position 1122, which is aligned with the center optical axis of the moveable mirror of the light scanner 1120, corresponds to a point of origin of the horizontal dimension of the FOV. As a result, a scanning pattern generated by using the transmission beams 1140A emitted by the first transmitter group 1110A has a negative scanning range that is substantially the same as a positive scanning range in the horizontal dimension of the FOV. In the configuration shown in FIG. 11B, a scanning pattern generated by using the transmission beams 1140B emitted by the second transmitter group 1110B has a negative scanning range that is greater than a positive scanning range in the horizontal dimension of the FOV. A scanning pattern generated by using the transmission beams 1140C emitted by the third transmitter group 1110C has a negative scanning range that is less than a positive scanning range in the horizontal dimension of the FOV. This is described in detail further below with reference to FIG. 12B.

As shown in FIG. 11B, tilt angles θₐ₂, θ_{b2}, and θ_{c2} associated with the plurality of transmitter groups 1110A-C are configured such that transmission beams 1140A-C emitted from neighboring transmitter groups converge. The letter a, b, or c in a subscript denotes the tilt angle associated with the corresponding transmitter groups 1110A, 1110B or 1110C. The number 2 in a subscript denotes the tilt angle at the particular angular position of light scanner 1120 shown in FIG. 11B. Further, in this example, the second transmitter group 1110B and the third transmitter group 1110C are symmetrically (i.e., θ_{b2}=θ_{c2}) spaced apart from the first transmitter group 1110A. The scanning pattern as a result of this configuration of symmetrically spaced apart is described in detail further below with reference to FIG. 12B.

FIG. 11C illustrates another example, in which the first transmitter group 1110A is positioned and/or oriented such that transmission beams 1140A are directed toward the position 1122 aligned with the center optical axis of the moveable mirror of the light scanner 1120. Tilt angles θₐ₃, θ_{b3}, and θ_{c3} associated with the plurality of transmitter groups 1110A-C are configured such that transmission beams 1140A-C emitted from neighboring transmitter groups diverge. The letter a, b, or c in a subscript denotes the tilt angle associated with the corresponding transmitter groups 1110A, 1110B or 1110C. The number 3 in a subscript denotes the tilt angle at the particular angular position of light scanner 1120 shown in FIG. 11C. In this example shown in FIG. 11C, the second transmitter group 1110B and the third transmitter group 1110C are asymmetrically (i.e., θ_{b3}≠θ_{c3}) spaced apart from the first transmitter group 1110A. The scanning pattern as a result of this configuration of asymmetrically spaced apart is described in detail further below with reference to FIG. 12C.

In the above example shown in FIG. 11A, the transmitter groups 1110B and 1110C are asymmetrically spaced apart from transmitter group 1110A, and are configured such that the FOV scannable by transmission beams 1140A-C emitted from the plurality of transmitter groups 1110A-C is greater than, or different from, the FOV scannable by transmission beams 1140A emitted from a single transmitter group 1110A. In the above example shown in FIG. 11B, the transmitter groups 1110B and 1110C are symmetrically spaced apart from 1110A, and are configured (e.g., oriented to have certain pitch, yaw, roll) such that the transmission beams 1140A-C converge. In the above example shown in FIG. 11C, the transmitter groups 1110B and 1110C are asymmetrically spaced apart from 1110A, and are configured (e.g., oriented to have certain pitch, yaw, roll) such that the transmission beams 1140A-C diverge. It is understood that other configurations and positioning of the transmitter groups 1110A-1110C can be implemented according to different scanning requirements.

FIGS. 12A-12C are diagrams illustrating examples of scanning patterns generated by a plurality of transmitter groups according to some embodiments. Scanning patterns 1210A-C shown in FIGS. 12A-12C are generated by the plurality of transmitter groups 1110A-C, respectively, shown in FIGS. 11A-11C. As shown in FIGS. 12A-12C, shapes of a FOV and point cloud density distributions are configurable based on one or more characteristics associated with the plurality of transmitter groups 1110A-C. Referencing FIGS. 11A-11C, the one or more characteristics comprise horizontal distances between the plurality of transmitter groups 1110A-C, vertical distances between the plurality of transmitter groups 1110A-C, and tilt angles associated with each of the plurality of transmitter groups 1110A-C.

FIG. 12A illustrates an extended FOV in both horizontal and vertical dimensions generated by the plurality of transmitter groups 1110A-C. The one or more characteristics associated with the plurality of transmitter groups 1110A-C are shown in FIG. 11A. As shown in FIG. 12A, scanning patterns 1210A-C generated by transmission beams emitted from two or more of the plurality of transmitter groups 1110A-C at least partially overlap. The overlapping regions are high density point cloud regions. The term “overlap” in this disclosure refers to overlap between scanning patterns, which may or may not correspond to overlap in horizontal and/or vertical scanning ranges. As an example, two scanning patterns with a similar horizontal scanning range may or may not have an overlap between them, depending on their vertical scanning ranges. Two scanning patterns with a similar vertical scanning range may or may not have an overlap between them, depending on their horizontal scanning ranges. In another example, two scanning patterns with both similar horizontal scanning range and similar vertical scanning range may have an overlap between them.

As shown in FIG. 12A, the scanning patterns 1210B and 1210C are asymmetrical, because the second transmitter group 1110B and the third transmitter groups 1110C are asymmetrically spaced apart from the first transmitter group 1110A shown in FIG. 11A.

As shown in FIG. 12A, each scanning pattern 1210A, 1210B, or 1210C generated by a single transmitter group is a limited FOV. Using multiple transmitter groups disposed at different positions with same/different orientations with respect to each other, an extended FOV can be obtained based on a combination of the limited FOVs. The horizontal FOV scannable by transmission beams emitted from two or more transmitter groups of the plurality of transmitter groups is greater than, or different from, the horizontal FOV scannable by transmission beams emitted from a single transmitter group of the plurality of transmitter groups. Similarly, the vertical FOV scannable by transmission beams emitted from two or more transmitter groups of the plurality of transmitter groups is greater than, or different from, the vertical FOV scannable by transmission beams emitted from a single transmitter group of the plurality of transmitter groups.

FIG. 12B illustrates another example of scanning patterns 1210A-C generated by the plurality of the transmitter groups 1110A-C. The one or more characteristics associated with the plurality of transmitter groups 1110A-C are shown in FIG. 11B. Referencing FIG. 11B, the tilt angle associated with each of the plurality of transmitter groups 1110A-C is configured such that the transmission beams 1140A-C emitted from neighboring transmitter groups converge. As a result, FIG. 12B shows that there is an overlap between the scanning patterns 1210A and 1210B, and another overlap between the scanning patterns 1210A and 1210C. Further, in some examples, there may be a high density point cloud region in the center of the horizontal FOV overlapped by the three scanning patterns 1210A-C. In other examples, there is no overlapping of the scanning patterns 1210A and 1210C.

As shown in FIG. 12B, the scanning patterns 1210B and 1210C are symmetrical, because the second transmitter group 1110B and the third transmitter groups 1110C are symmetrically spaced apart from the first transmitter group 1110A shown in FIG. 11B. As shown in FIG. 12B, the scanning pattern 1210A generated by using the transmission beams emitted by the first transmitter group 1110A has a negative scanning range that is substantially the same as a positive scanning range in the horizontal dimension of the FOV. This is because the first transmitter group 1110A is disposed at the position aligned with the center optical axis of the moveable mirror of the light scanner. The scanning pattern 1210B generated by using the transmission beams emitted by the second transmitter group 1110B has a negative scanning range that is greater than a positive scanning range in the horizontal dimension of the FOV. The scanning pattern 1210C generated by using the transmission beams emitted by the third transmitter group 1110C has a negative scanning range that is less than a positive scanning range in the horizontal dimension of the FOV.

FIG. 12C illustrates another example of scanning patterns 1210A-C generated by the plurality of the transmitter groups 1110A-C. The one or more characteristics associated with the plurality of transmitter groups 1110A-C are shown in FIG. 11C. Referencing FIG. 11C, the tilt angle associated with each of the plurality of transmitter groups 1110A-C is configured such that the transmission beams 1140A-C emitted from neighboring transmitter groups diverge. As a result, FIG. 12C shows that there may be no overlap among the scanning patterns 1210A-C. FIGS. 12B and 12C illustrate that overlapping of the scanning patterns to obtain high point cloud density are configurable by adjusting the tilt angles associated with the plurality of transmitter groups 1110A-C.

As shown in FIG. 12C, the scanning patterns 1210B and 1210C are asymmetrical shown in FIG. 12C, because the second transmitter group 1110B and the third transmitter groups 1110C are asymmetrically spaced apart from the first transmitter group 1110A, as shown in FIG. 11C. Similar to FIG. 12B, the scanning pattern 1210A has a negative scanning range that is substantially the same as a positive scanning range in the horizontal dimension of the FOV shown in FIG. 12C, because the first transmitter group 1110A is disposed at the position aligned with the center optical axis of the moveable mirror of the light scanner. As also shown in FIG. 12C, in some examples, the transmitter groups (e.g., 1110A-1110C) are configured such that the scanning pattern 1210B has a negative scanning range that is greater than a positive scanning range in the horizontal dimension of the FOV. The scanning pattern 1210C is entirely in the positive horizontal angle area. In some examples, the scanning pattern 1210B generated by using the transmission beams emitted by the second transmitter group 1110B may be entirely in the negative angle area. The scanning pattern 1210C generated by using the transmission beams emitted by the third transmitter group 1110C has a negative scanning range that is less than a positive scanning range in the horizontal dimension of the FOV. FIG. 12C shows that none of the scanning patterns 1210A-1210C overlap, while they may have the same or similar vertical scanning range. In other embodiments, the scanning patterns 1210A-1210C may be different vertical scanning ranges, and they may not overlap. For instance, the transmitter groups (e.g., 1110A-1110C) may be configured (positioned and/or oriented) such that scanning pattern 1210B covers a different vertical scanning range than scanning pattern 1210A, and has no overlap with scanning pattern 1210A vertically and/or horizontally. Scanning pattern 1210B may or may not be entirely in the negative scanning range. Similarly, the transmitter groups (e.g., 1110A-1110C) may be configured (positioned and/or oriented) such that scanning pattern 1210C covers a different vertical scanning range than scanning pattern 1210A, and has no overlap with scanning pattern 1210A vertically and/or horizontally. Scanning pattern 1210C may or may not be entirely in the positive scanning range.

The above descriptions illustrate that using a plurality of transmitter groups (e.g., 1110A-C shown in FIG. 11A-C) disposed at different positions with respect to a light scanner 1120, an extended FOV (e.g., beyond 120 degrees) can be obtained, thereby improving the scanning range of the LiDAR system and improving scanning resolution in at least certain overlapping regions. Further, shapes of scanning patterns and point cloud density distributions are highly customizable. This facilitates the LiDAR system to fulfill complicated perception requirements. FIGS. 12A-12C only illustrate three kinds of examples for the scanning patterns generated by the plurality of transmitter groups, but it is understood that other configurations for the scanning patterns can be obtained by adjusting tilt angles associated with the plurality of transmitter groups.

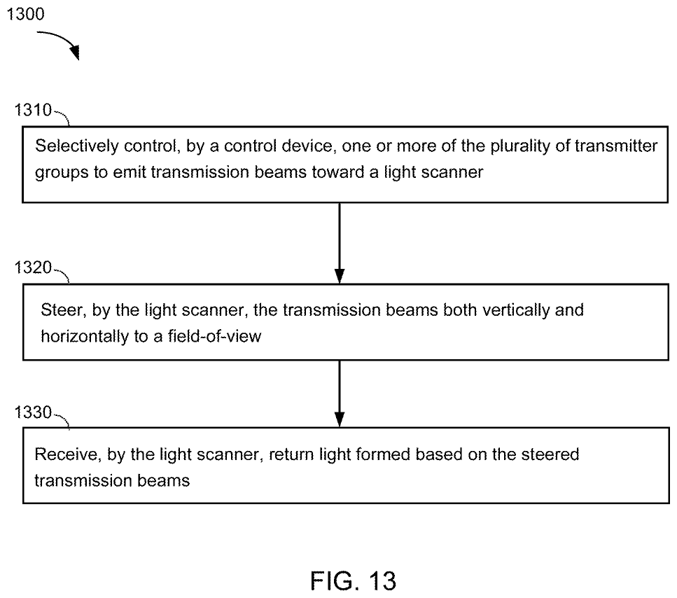

FIG. 13 shows a flowchart illustrating an example method 1300 for controlling a LiDAR system according to some embodiments. The LiDAR system comprises a light scanner (e.g., movable mirror 720 and polygon mirror 730 shown in FIG. 7, and light scanner 1120 shown in FIGS. 11A-11C) and a plurality of transmitter groups (e.g., transmitter groups 710A-C shown in FIG. 7, and transmitter groups 1110A-C shown in FIGS. 11A-11C) optically couplable to the light scanner.

In step 1310 of the method 1300, a control device selectively controls one or more of the plurality of transmitter groups to emit transmission beams toward the light scanner. At least two transmitter groups of the plurality of transmitter groups are disposed at different positions with respect to the light scanner such that scanning areas corresponding to the at least two transmitter groups are different.

In some embodiments, the selectively controlling of one or more of the plurality of transmitter groups comprises controlling at least one of: an on/off state of each of the one or more of the plurality of transmitter groups; a pulse repetition rate of each transmission beam emitted by the one or more of the plurality of transmitter groups; a power level of each transmission beam emitted by the one or more of the plurality of transmitter groups; a wavelength of each transmission beam emitted by the one or more of the plurality of transmitter groups; an encoding or modulation scheme of each transmission beam emitted by the one or more of the plurality of transmitter groups; and a combination of the transmitter groups that emit transmission beams toward the light scanner. In some embodiments, the selectively controlling one or more of the plurality of transmitter groups is based on at least one of predetermined settings or vehicle perception requirements.

In step 1320 of the method 1300, the light scanner steers the transmission beams both vertically and horizontally to a FOV. In step 1330 of the method 1300, the light scanner receives return light formed based on the steered transmission beams.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A system for light ranging and detection (LiDAR), the system comprising:
a light scanner;
a plurality of transmitter groups optically couplable to the light scanner, each transmitter group of the plurality of transmitter groups comprising a plurality of transmitters, wherein at least two transmitter groups of the plurality of transmitter groups are disposed at different positions with respect to the light scanner such that scanning areas corresponding to the at least two transmitter groups are different;
a control device configured to selectively control one or more of the plurality of transmitter groups to emit transmission beams toward the light scanner,
wherein the light scanner is configured to:
steer the transmission beams both vertically and horizontally to a field-of-view (FOV), and
receive return light formed based on the steered transmission beams.

2. The system of claim 1, further comprising a housing, wherein the light scanner and the plurality of transmitter groups are disposed within the housing.

3. The system of claim 1, wherein the light scanner comprises:
an oscillation mirror and a polygon mirror, the oscillation mirror being configured to direct the transmission beams to the polygon mirror, wherein:
the oscillation mirror facilitates scanning the transmission beams along a first dimension of the FOV, and
the polygon mirror facilitates scanning the transmission beams along a second dimension of the FOV, the second dimension being orthogonal to the first dimension.

4. The system of claim 1, wherein the plurality of transmitter groups and a moveable mirror of the light scanner are optically coupled together such that transmission beams emitted by the plurality of transmitter groups are receivable by the moveable mirror.

5. The system of claim 4, wherein the transmission beams emitted by the plurality of transmitter groups are optically coupled to one or more collimation lenses or lens groups.

6. The system of claim 1, further comprising a collection lens, wherein one or more of the plurality of transmitter groups are at least partially disposed in one or more openings of the collection lens or disposed on the sides of the collection lens.

7. The system of claim 1, wherein one or more characteristics associated with the plurality of transmitter groups are configured based on at least one of a vertical FOV requirement or a horizontal FOV requirement.

8. The system of claim 7, wherein the one or more characteristics comprise horizontal distances between the plurality of transmitter groups, vertical distances between the plurality of transmitter groups, and tilt angles associated with each of the plurality of transmitter groups.

9. The system of claim 8, wherein the horizontal distances between the plurality of transmitter groups are configured such that the horizontal FOV scannable by transmission beams emitted from two or more transmitter groups of the plurality of transmitter groups is greater than, or different from, the horizontal FOV scannable by transmission beams emitted from one transmitter group of the plurality of transmitter groups.

10. The system of claim 8, wherein the vertical distances between the plurality of transmitter groups are configured such that the vertical FOV scannable by transmission beams emitted from two or more transmitter groups of the plurality of transmitter groups is greater than, or different from, the vertical FOV scannable by transmission beams emitted from one transmitter group of the plurality of transmitter groups.

11. The system of claim 8, wherein the tilt angle associated with each of the plurality of transmitter groups is configured such that transmission beams emitted from neighboring transmitter groups converge.

12. The system of claim 8, wherein the tilt angle associated with each of the plurality of transmitter groups is configured such that transmission beams emitted from neighboring transmitter groups diverge.

13. The system of claim 1, wherein the plurality of transmitter groups comprises a first transmitter group, a second transmitter group, and a third transmitter group, wherein the second transmitter group is disposed at the left side of the first transmitter group, and wherein the third transmitter group is disposed at the right side of the first transmitter group.

14. The system of claim 13, wherein the second transmitter group and the third transmitter groups are symmetrically spaced apart from the first transmitter group.

15. The system of claim 13, wherein the second transmitter group and the third transmitter groups are asymmetrically spaced apart from the first transmitter group.

16. The system of claim 13, wherein the transmission beams emitted from first transmitter group are directed toward a position aligned with a center optical axis of a moveable mirror of the light scanner such that a scanning pattern generated by using the transmission beams emitted by the first transmitter group has a negative scanning range that is substantially the same as a positive scanning range in the horizontal dimension of the FOV.

17. The system of claim 13, wherein a scanning pattern generated by using the transmission beams emitted by the second transmitter group has a negative scanning range that is greater than a positive scanning range in the horizontal dimension of the FOV.

18. The system of claim 13, wherein a scanning pattern generated by using the transmission beams emitted by the third transmitter group has a negative scanning range that is less than a positive scanning range in the horizontal dimension of the FOV.

19. The system of claim 13, wherein each of the first, second, and third transmitter groups comprises a 1-by-4 fiber array.

20. The system of claim 13, wherein the first transmitter group comprises a 1-by-4 fiber array, and wherein each of the second and third transmitter groups comprises a 1-by-2 or 1-by-3 fiber array.

21. The system of claim 1, wherein at least two of plurality of transmitter groups comprise different types of laser sources.

22. The system of claim 1, wherein the plurality of transmitter groups comprise one or more semiconductor-based laser sources and/or one or more fiber-based laser sources.

23. The system of claim 1, wherein at least two of the plurality of transmitter groups are configured to emit transmission beams having different wavelengths.

24. The system of claim 1, wherein the plurality of transmitter groups comprise a plurality of transmitter arrays, each of the transmitter arrays comprises a plurality of transmitters aligned with each other in at least one of a horizontal and vertical dimensions.

25. The system of claim 24, wherein any one of the plurality of transmitter arrays comprises a n-by-m array, wherein 1≤n≤100 and 1≤m≤100.

26. The system of claim 1, wherein the control device is configured to selectively control the one or more of the plurality of transmitter groups by controlling at least one of:
an on/off state of each of the one or more of the plurality of transmitter groups;
a pulse repetition rate of each transmission beam emitted by the one or more of the plurality of transmitter groups;
a power level of each transmission beam emitted by the one or more of the plurality of transmitter groups;
a wavelength of each transmission beam emitted by the one or more of the plurality of transmitter groups;
an encoding or modulation scheme of each transmission beam emitted by the one or more of the plurality of transmitter groups; and
a combination of the transmitter groups that emit transmission beams toward the light scanner.

27. The system of claim 1, wherein the control device is configured to selectively control the one or more of the plurality of transmitter groups based on one or more perception requirements.

28. The system of claim 1, wherein scanning patterns generated by transmission beams emitted from two or more of the plurality of transmitter groups at least partially overlap.

29. A vehicle comprising a system for light ranging and detection (LiDAR), the system comprising:
a light scanner;
a plurality of transmitter groups optically couplable to the light scanner, each transmitter group of the plurality of transmitter groups comprising a plurality of transmitters, wherein at least two transmitter groups of the plurality of transmitter groups are disposed at different positions with respect to the light scanner such that scanning areas corresponding to the at least two transmitter groups are different;
a control device configured to selectively control one or more of the plurality of transmitter groups to emit transmission beams toward the light scanner,
wherein the light scanner is configured to:
steer the transmission beams both vertically and horizontally to a field-of-view (FOV), and
receive return light formed based on the steered transmission beams.

30. A method for controlling a light ranging and detection (LiDAR) system comprising a light scanner and a plurality of transmitter groups optically couplable to the light scanner, the method comprising:
selectively controlling, by a control device, one or more of the plurality of transmitter groups to emit transmission beams toward the light scanner, wherein at least two transmitter groups of the plurality of transmitter groups are disposed at different positions with respect to the light scanner such that scanning areas corresponding to the at least two transmitter groups are different;
steering, by the light scanner, the transmission beams both vertically and horizontally to a field-of-view (FOV), and
receiving, by the light scanner, return light formed based on the steered transmission beams.

31. The method of claim 30, wherein selectively controlling one or more of the plurality of transmitter groups comprises controlling at least one of:
an on/off state of each of the one or more of the plurality of transmitter groups;
a pulse repetition rate of each transmission beam emitted by the one or more of the plurality of transmitter groups;
a power level of each transmission beam emitted by the one or more of the plurality of transmitter groups;
a wavelength of each transmission beam emitted by the one or more of the plurality of transmitter groups;
an encoding or modulation scheme of each transmission beam emitted by the one or more of the plurality of transmitter groups; and
a combination of the transmitter groups that emit transmission beams toward the light scanner.

32. The method of claim 30, wherein selectively controlling one or more of the plurality of transmitter groups is based on at least one of predetermined settings or vehicle perception requirements.
